(19) United States
(12) Patent Application Publication
(10) Pub. No.: US 2018/0343166 A1
(43) Pub. Date: Nov. 29, 2018

(54) METHOD AND APPARATUS FOR MULTI-MODEL POLICY TERM CONSOLIDATION WITH MUTATING GRAPHS

(71) Applicants: Guangnian WU, Kanata (CA); Tibor FASANGA, Stittsville (CA)

(72) Inventors: Guangnian WU, Kanata (CA); Tibor FASANGA, Stittsville (CA)

(21) Appl. No.: 15/605,671

(22) Filed: May 25, 2017

(51) Int. Cl. H04L 12/24; H04L 7/00

(52) U.S. Cl. CPC H04L 41/0893; H04L 41/12; H04L 7/0008

(57) ABSTRACT

Various embodiments relate to a method for synchronization of a first set of policy terms with a second set of policy terms by performing iteration on the second set of policy terms, the method comprising the steps of verifying whether there is a path in a directed linear graph for a first set of policy terms connecting a preceding term in the second set of policy terms to a current term in the second set of policy terms and dropping the current term in the second set of policy terms from a directed graph for a second set of policy terms and keeping the subsequent term in the second set of policy terms.

### TECHNICAL FIELD

This disclosure relates generally to synchronization of routing policy configurations, and more specifically, but not exclusively, to providing a method for existing network management systems to consolidate entries having textual identification with entries having numerical identification.

### BACKGROUND

Routing policy configuration on different types of multi-service routers from different vendors is difficult to synchronize due to the different types of definitions for each statement term.

Statement terms can be addressed by their Entry IDs or their Term Names, for example, Entry IDs 1000, 2000 or 3000 or their Term Names: AcceptBGP, AcceptAll, RejectOSPF

The definition of each statement term (either through Entry IDs or Term Names) and the order of evaluation are equally important in routing policy configuration.

This order is critical in both cases and can be attained by sorting Entry IDs in Network Functions Manager for Packets (“NFM-P”). Since the numerical identification in the form of Entry IDs also carries partial ordering information, the NFM-P plays an advantage of supporting insertion and is thereby superior to the textual identification model (i.e., Term Names) used on the multi-service router equipment from the different vendors.

Insertion still has to be performed by an inefficient series of deletions followed by a series of additions.

### SUMMARY OF EXEMPLARY EMBODIMENTS

A brief summary of various embodiments is presented below. Embodiments address the need to integrate and develop a method for existing network management systems to consolidate entries having textual identification with entries having numerical identification.

In order to overcome these and other shortcomings of the prior art and in light of the present need to integrate and develop a method for existing network management systems to consolidate entries having textual identification with entries having numerical identification, a brief summary of various exemplary embodiments is presented. Some simplifications and omissions may be made in the following summary, which is intended to highlight and introduce some aspects of the various exemplary embodiments, but not to limit the scope of the invention.

Detailed descriptions of a preferred exemplary embodiment adequate to allow those of ordinary skill in the art to make and use the inventive concepts will follow in later sections.

Various embodiments described herein relate to a method for synchronization of a first set of policy terms with a second set of policy terms by performing iteration on the second set of policy terms, the method including the steps of verifying whether there is a path in a directed linear graph for a first set of policy terms connecting a preceding term in the second set of policy terms to a current term in the second set of policy terms and dropping the current term in the second set of policy terms from a directed graph for a second set of policy terms and keeping the subsequent term in the second set of policy terms.

In an embodiment of the present disclosure, the method further including determining whether every term in the second set of policy terms is in the first set of policy terms and if any term in the second set of policy terms is not in the first set of policy terms, the term is dropped from the second set of policy terms.

In an embodiment of the present disclosure, the method further including evaluating a term subsequent to the current term by verifying whether there is a path in the directed graph for the first set of policy terms connecting a preceding term in the second set of policy terms to the term in the second set of policy terms.

In an embodiment of the present disclosure, the method further including generating the directed graph for the second set of policy terms wherein the current term is dropped.

In an embodiment of the present disclosure, the method further including terminating the method when a third set of policy terms for the directed linear graph for the second set of policy terms are less than a third set of policy terms for another directed linear graph for a second set of policy terms wherein the third set of policy terms are network management system retained terms.

In an embodiment of the present disclosure, the first set of policy terms are network management system terms, the second set of policy terms are network equipment terms.

Various embodiments described herein relate to a method for synchronization of a first set of policy terms with a second set of policy terms by performing iteration on the second set of policy terms, the method including the steps of verifying whether there is a path in a directed linear graph for a first set of policy terms connecting a preceding term in the second set of policy terms to a current term in the second set of policy terms and keeping the current term in the second set of policy terms from a directed graph for a second set of policy terms and dropping the preceding term in the second set of policy terms.

In an embodiment of the present disclosure, the method further including determining whether every term in the second set of policy terms is in the first set of policy terms and if any term in the second set of policy terms is not in the first set of policy terms, the term is dropped from the second set of policy terms.

In an embodiment of the present disclosure, the method further including reevaluating the current term by verifying whether there is a path in the directed linear graph for the first set of policy terms connecting a preceding term in the second set of policy terms to the current term in the second set of policy terms.

In an embodiment of the present disclosure, the method further including generating a directed graph for a second set of policy terms wherein the current term is retained.

In an embodiment of the present disclosure, the method further including terminating the method when a third set of policy terms for the directed linear graph for the second set of policy terms are less than a third set of policy terms for another directed linear graph for a second set of policy terms wherein the third set of policy terms are network management system retained terms.

In an embodiment of the present disclosure, the first set of policy terms are network management system terms, the second set of policy terms are network equipment terms.

Various embodiments described herein relate to a non-transitory machine-readable storage medium encoded with instructions executable to perform a method by a processor for synchronization of a first set of policy terms with a second set of policy terms by performing iteration on the second set of policy terms, the machine-readable storage medium including instructions for verifying whether there is a path in a directed linear graph for a first set of policy terms connecting a preceding term in the second set of policy terms to a current term in the second set of policy terms and instructions for dropping the current term in the second set of policy terms from a directed graph for a second set of policy terms and keeping the subsequent term in the second set of policy terms.

In an embodiment of the present disclosure, the non-transitory machine-readable storage medium further includes instructions for determining whether every term in the second set of policy terms is in the first set of policy terms and if any term in the second set of policy terms is not in the first set of policy terms, the term is dropped from the second set of policy terms.

In an embodiment of the present disclosure, the non-transitory machine-readable storage medium further includes instructions for evaluating a term subsequent to the current term by verifying whether there is a path in the directed graph for the first set of policy terms connecting a preceding term in the second set of policy terms to the term in the second set of policy terms.

In an embodiment of the present disclosure, the non-transitory machine-readable storage medium further includes instructions for generating the directed graph for the second set of policy terms wherein the current term is dropped.

In an embodiment of the present disclosure, the non-transitory machine-readable storage medium further includes instructions for terminating the method when a third set of policy terms for the directed linear graph for the second set of policy terms are less than a third set of policy terms for another directed linear graph for a second set of policy terms, wherein the third set of policy terms are network management system retained terms.

In an embodiment of the present disclosure, the first set of policy terms are network management system terms, the second set of policy terms are network equipment terms.

Various embodiments described herein relate to a non-transitory machine-readable storage medium encoded with instructions executable to perform a method by a processor for synchronization of a first set of policy terms with a second set of policy terms by performing iteration on the second set of policy terms, the machine-readable storage medium includes instructions for verifying whether there is a path in a directed linear graph for a first set of policy terms connecting a preceding term in the second set of policy terms to a current term in the second set of policy terms and instructions for keeping the current term in the second set of policy terms from a directed graph for a second set of policy terms and dropping the preceding term in the second set of policy terms.

In an embodiment of the present disclosure, the non-transitory machine-readable storage medium of claim 19, further includes instructions for determining whether every term in the second set of policy terms is in the first set of policy terms and if any term in the second set of policy terms is not in the first set of policy terms, the term is dropped from the second set of policy terms.

In an embodiment of the present disclosure, the non-transitory machine-readable storage medium, further includes instructions for reevaluating the current term by verifying whether there is a path in the directed linear graph for the first set of policy terms connecting a preceding term in the second set of policy terms to the current term in the second set of policy terms.

In an embodiment of the present disclosure, the non-transitory machine-readable storage medium further includes instructions for generating a directed graph for a second set of policy terms wherein the current term is retained.

In an embodiment of the present disclosure, the non-transitory machine-readable storage medium further includes instructions for terminating the method when a third set of policy terms for the directed linear graph for the second set of policy terms are less than a third set of policy terms for another directed linear graph for a second set of policy terms, wherein the third set of policy terms are network management system retained terms.

In an embodiment of the present disclosure, the first set of policy terms are network management system terms, the second set of policy terms are network equipment terms.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

These and other more detailed and specific features are more fully disclosed in the following specification, reference being had to the accompanying drawings, in which:

FIG. 1 illustrates an example of the existing solution of looping through network elements terms in ascending order.

FIG. 2 illustrates an example of a network management terms set being rearranged into a network element terms set by running the algorithm which results in obtaining the optimal network management system retaining terms set by dropping the current term.

FIG. 3 illustrates an example of network management terms set being rearranged into network element terms set by running the algorithm which results in obtaining the optimal network management system retaining terms set by keeping the current term.

FIG. 4 illustrates a flowchart for a method for existing network management systems to consolidate entries having textual identification with entries having numerical identification

### DETAILED DESCRIPTION OF THE INVENTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. Descriptors such as “first,” “second,” “third,” etc., are not meant to limit the order of elements discussed, are used to distinguish one element from the next, and are generally interchangeable.

A method is needed to integrate and develop a method for existing network management systems to consolidate entries having textual identification with entries having numerical identification.

Currently, multi-vendor support (i.e., having different vendors with multi-service routers) requires existing network management systems that implement numerical identification (i.e., Entry IDs) to be able to consolidate with entries that implement textual identification (i.e., Term Names) from network equipment of different vendors in order for interoperability and convergence with network equipment from different vendors adopting numerical identifications.

For example, a subject network management system has a list of policy terms. These policy terms are denoted as NMS_Terms.

NMS_Terms={sᵢ|1<=i<=n}, where entry_id_nms(sᵢ)<entry_id_nms(sᵢ₊₁).

Therefore, |NMS_Terms|=n and term_index_s(sᵢ)<term_index_s(sᵢ₊₁).

Furthermore, because entry_id is the key: s=NMS_Terms[entry_id_nms(s)].

Network Equipment A has a list of policy terms.

These policy terms are denoted as NE_Terms.

NE_Terms={eᵢ|1<=i<=m}, where term_index_equip(eᵢ)<term_index_equip(eᵢ₊₁).

Therefore, |NE_Terms|=m

Furthermore, because term_name is the key: e=NE_Terms[term_name_equip(e)].

The function mapToNE(s)=NE_Terms[term_name_sys(s)], where s belongs to NMS_Terms.

The function mapToNMS(e)=NMS_Terms[term_name_equip(e)], where e belongs to NE_Terms.

Once the terms and functions have been defined, the synchronization procedure occurs by first, reading NE_Terms from the network equipment into the network management system.

The synchronization procedure then determines a subset named NMS_Retaining_Terms which is a subset of NMS_Terms as {s′ᵢ|1<=i<=o}, where entry_id_nms(s′ᵢ)<entry_id_nms(s′ᵢ₊₁), 1<=o<=n, and term_index_equip(mapToNE(s′ᵢ))<term_index_equip (mapToNE(s′ᵢ₊₁)).

Therefore, |NMS_Retaining_Terms|=o.

The synchronization procedure then deletes any elements of NMS_Terms that are not members of the subset NMS_Retaining_Terms.

Finally, the synchronization procedure creates and initializes a new member of NMS_Terms for each member of NE_Terms e, such that term_name_equip(e) !=term_name_sys(s′) for all members of NMS_Retaining_Terms.

Assuming all policy terms have the same size in content, the only variable in terms of actual implementation performance is the size of NMS_Retaining_Terms.

The cost of the reading the NE_Terms and determining the subset NMS_Retaining_Terms are either constant or negligible (in memory).

Meanwhile, the cost of deleting elements that are not part of NMS_Retaining_Terms and creating and initializing new members, both involve costly database transactions.

Therefore, as costly database transactions are required in the current synchronization procedure, an algorithm to determine a largest NMS_Retaining_Terms is needed and would be considered optimal.

The current synchronization procedure requires looping through NE_Terms in ascending order and if a member has its corresponding counterpart (same term name) in NMS_Terms, then checking the term index of the existing term. If this index is greater than current_term_index (initialized to 0), then update current_term_index with this index and add this existing term to the end of NMS_Retaining_Terms:

```
Initialize NMS_Retaining_Tems to { }, current_term_index to 0
FOR i = 1 to m
SET x to mapToNMS (eᵢ)
IF x != null AND term_index_s(x) > current_term_index THEN
        SET current_term_index to term_index_s(x)
        Add x to end of NMS_Retaining_Terms
ENDIF
ENDFOR
```

In order to show that an optimal result can be attained by the current synchronization procedure, it must be shown that all possible results are considered, either directly or indirectly.

The current synchronization procedure fails this condition as every time a term is retained, the possibility that it is not part of an optimal result is prevented from being evaluated.

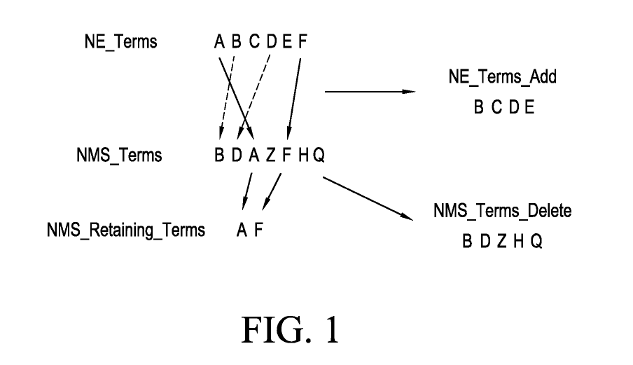

For example, FIG. 1 illustrates the current synchronization procedures resulting in NMS_Retaining_Terms [A, F], which is not the largest possible subset, as the largest possible subset is [B, D, F].

As seen in FIG. 1, NE_Terms are [A, B, C, D, E, F] and NMS_Terms are [B, D, A, Z, F, H, Q]. The solid lines represent NE_Terms which are retained and the dotted lines represent NE_Terms which are dropped.

For example, using the current synchronization procedure described above, the NE_Term A will be retained because there is a counterpart A term in the NMS_Terms and if the term index of A is greater than the current term index then the current term index is updated to the term index and the term is added to the NMS_Retaining_Terms subset.

The term index of NE_Term A is 2 because the term index of term A in the NMS_Terms set is 2 and because 2 is greater than the current term index which is 0, the current term index is changed from 0 to 2 and term A is added to the NMS_Retaining_Terms subset. NE_Term F is also added to the NMS_Retaining_Terms subset because the current term index is 2 and the term index of term F is 4, because 4 is greater than 2, Term F is added to the NMS_Retaining_Terms subset and the current term index is changed from 2 to 4.

NE_Terms B and D will be not be added to the NMS_Retaining_Terms subset because while they have counterparts in the NMS_Terms set, the term index for B is 0 which is less than the current term index which is 2 and the term index for D is 1 which is less than the current term index which is 2. Terms B and D will be added to the NMS_Terms_Delete subset and added to the NE_Terms_Add subset.

NE_Terms C and E will not be evaluated as terms C and E do not have counterparts in the NMS_Terms set, therefore, terms C and E will be added to the NE_Terms_Add subset.

NMS_Terms Z, H and Q will also be added to the NMS_Terms_Delete subset.

However, the current synchronization method is not optimal as the resulting NMS_Retaining_Terms subset is [A, F], however, the maximum number of NMS_Retaining_Terms subset is [B, D, F].

By using directed linear graphs to represent NE_Terms and NMS_Retaining_Terms, the optimal number of NMS_Retaining_Terms subset can be obtained.

The NMS_Terms are defined as {s₁, s₂, . . . , sₙ}.

The NE_Terms are defined as {e₁, e₂, . . . , eₘ}.

For example, let x, and xₖ be two elements of such a directed linear graph, there exists a path xᵢ, . . . , xₖ if and only if i<k.

Due to the observation that any result has to be isomorphic to a subset of both of them based on term name matching, iteration is performed on NE_Terms with NMS_Terms as reference such that if a member of NE_Terms has no counterpart in NMS_Terms, it is removed from NE_Terms graph, with preceding vertex (if any) directed straight to succeeding vertex (if any).

If this member has a corresponding counterpart in NMS_Terms, then verification is performed to ensure that there is a path in reference NMS_Terms connecting counterpart of preceding vertex to which of current member.

Otherwise, these two elements (current and preceding) are incompatible (to be in the same result) and a decision has to be made as to which element to keep.

Once that decision has been made, the current NE_Terms graph is replaced with two distinct partially processed graphs, each with one element in question retained and the other removed.

If current vertex is removed, then the iteration pointer goes to next vertex on the path, otherwise current position will be re-evaluated with modified graph with new preceding vertex (if any).

This process is repeated on each of the processed graphs.

Depending on whether parallel processing is adopted some iterations may terminate midway, if the size of current NE_Terms graph to process is already less than the size of largest result graphs at that time.

When all iterations have terminated, the subset of the largest of resulting graphs is determined and their elements from NE_Terms to NMS_Terms are mapped and the largest and optimal NMS_Retaining_Terms is determined.

The pseudocode for a single iteration is illustrated below:

```
        Initialize stack Processing_Stack to {{NE_Terms, 1}},
NMS_Retaining_Terms to { }, current_largest_result_size = 0
    WHILE |Processing_Stack| != 0
        SET Processing_Entry to pop Processing_Stack
        SET NE_Terms\grave{ } to 1^{st} element of Processing_Entry
        SET i to 2^{nd} element of Processing_Entry
        SET prev to preceding element to eᵢ within NE_Terms\grave{ },
        null if non-existent
        IF current_largest_result_size > |NE_Terms\grave{ }| THEN
            CONTINUE
        ENDIF
        IF prev != null AND term_index_s(prev) > term_index_s(eᵢ)
        THEN
            Push {NE_Terms\grave{ }\{eᵢ}, i+1} to Processing_Stack
            Push {NE_Terms\grave{ }\{prev}, i} to Processing_Stack
        ELSE
            IF i = m THEN
                IF |NE_Terms\grave{ }| > current_largest_result_size THEN
                    SET NMS_Retaining_Terms to { }
                    SET current_largest_result_size to |NE_Terms\grave{ }|
                ENDIF
                Push {mapToNMS(x)| x is member of NE_Terms\grave{ }} to
            NMS_Retaining_Terms
            ELSE
                Push{ NE_Terms\grave{ }}, i+1} to Processing_Stack
            ENDIF
        ENDIF
    ENDWHILE
    RETURN NMS_Retaining_Terms
```

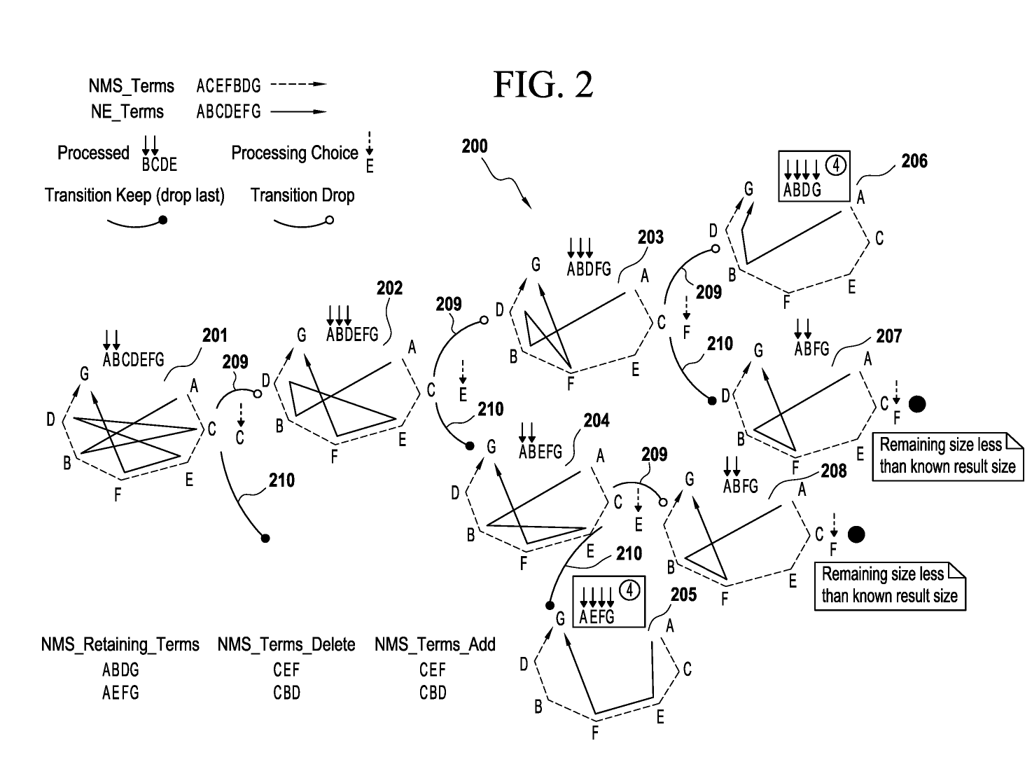

For example, FIG. 2 illustrates a mutating graph 200 with two directed linear graphs, NE_Terms and NMS_Terms.

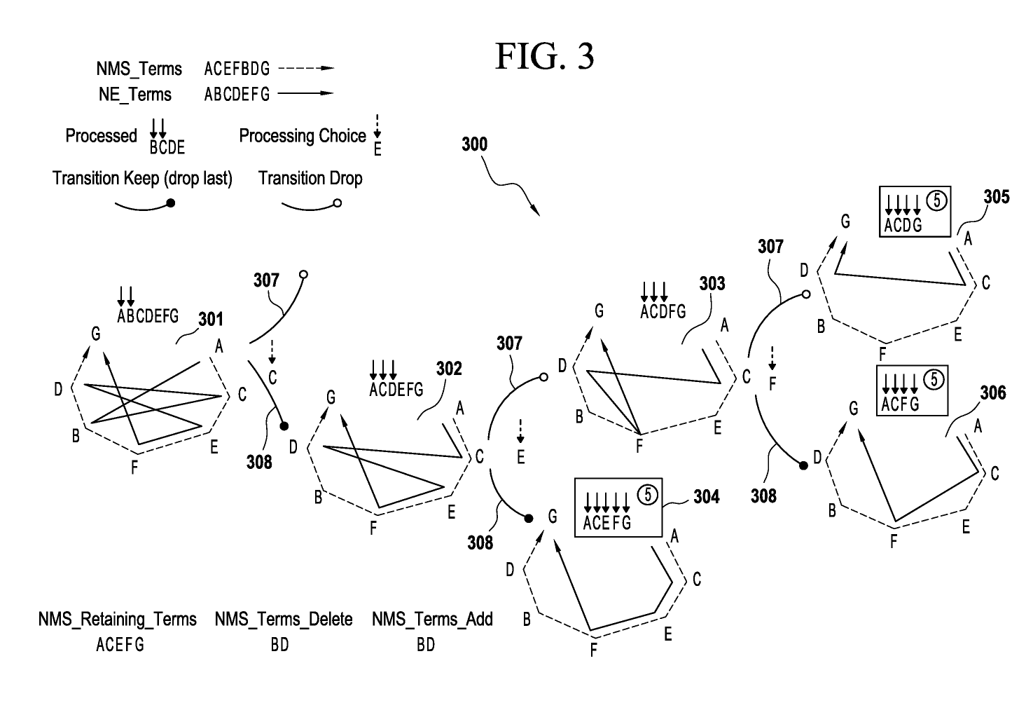

Graph 201 illustrates the combination of the two directed linear graphs, the NMS_Terms in dashed lines and the NE_Terms in solid lines. Graph 201 represents NMS_Terms A and B having been processed and processing NE_Term C. NE_Term C may be dropped 209 or retained 210. FIG. 2 illustrates the outcome when NE_Term C is dropped 209. FIG. 3 illustrates the outcome when NE_Term C is retained 210.

NE_Term C is determined to be dropped 209 because there is no direct path from the previous NE_Term B to the current NE_Term C in the direction of the NMS_Terms linear graph. Therefore, when NE_Term C is dropped 209, the segments in the NE_Terms graph which include NE_Term C are removed from the NE_Terms graph (i.e., the segment from NE_Term C to NE_Term D and from NE_Term C to NE_Term B). However, because these segments have been removed, a new segment must be added between NE_Term B and NE_Term D. Once NE_Term C has been dropped 209, the subsequent term, NE_Term D is processed and retained which is illustrated in graph 202.

Graph 203 illustrates the next NE_Term to be processed which is the NE_Term E and dropping 209 NE_Term E. NE_Term E is dropped 209 because there is no direct path from the previous NE_Term D to the current NE_Term E in the direction of the NMS_Terms linear graph. Therefore, when NE_Term E is dropped 209, the segments in the NE_Terms graph which include NE_Term E are removed from the NE_Terms graph (i.e., the segment from NE_Term E to NE_Term D and from NE_Term E to NE_Term F). However, because these segments have been removed, a new segment must be added between NE_Term D and NE_Term F. Once NE_Term E has been dropped 209, the subsequent term, NE_Term D remains processed and retained.

Graph 204 illustrates the NE_Term E being retained 210. When NE_Term E is retained 210, the segments in the NE_Terms graph which include NE_Term D are removed from the NE_Terms graph (i.e., the segment from NE_Term D to NE_Term B and from NE_Term D to NE_Term E). However, because these segments have been removed, a new segment must be added between NE_Term B and NE_Term E. Once NE_Term E has been retained 210, the preceding term, NE_Term D is dropped.

Graph 206 illustrates the next NE_Term to be processed which NE_Term F and dropping 209 NE_Term F. NE_Term F is dropped 209 because there is no direct path from the previous NE_Term D to the current NE_Term F in the direction of the NMS_Terms linear graph. Therefore, when NE_Term F is dropped 209, the segments in the NE_Terms graph which include NE_Term F are removed from the NE_Terms graph (i.e., the segment from NE_Term F to NE_Term D and from NE_Term G to NE_Term F). However, because these segments have been removed, a new segment must be added between NE_Term D and NE_Term G. Once NE_Term F has been dropped 209, the subsequent term, NE_Term G is processed and retained, at which point the NMS_Retaining_Terms subset is defined as {A, B, D, G}.

Graph 207 illustrates the NE_Term F being retained 210. When NE_Term F is retained 210, the segments in the NE_Terms graph which include NE_Term D are removed from the NE_Terms graph (i.e., the segment from NE_Term D to NE_Term B and from NE_Term D to NE_Term F). However, because these segments have been removed, a new segment must be added between NE_Term B and NE_Term F. Once NE_Term F has been retained 210, the preceding term, NE_Term D is dropped, however, NE_Terms are not further processed because the remaining size of the NMS_Retaining_Terms is less that a known size (i.e., four in graph 206).

Graph 208 illustrates the next NE_Term to be processed which is the NE_Term E and dropping 209 NE_Term E. NE_Term E is dropped 209 because there is no direct path from the previous NE_Term B to the current NE_Term E in the direction of the NMS_Terms linear graph. Therefore, when NE_Term E is dropped 209, the segments in the NE_Terms graph which include NE_Term E are removed from the NE_Terms graph (i.e., the segment from NE_Term F to NE_Term E and from NE_Term B to NE_Term E). However, because these segments have been removed, a new segment must be added between NE_Term B and NE_Term F. Once NE_Term E has been dropped 209, the subsequent term, NE_Term F is processed and retained, at which point, NE_Terms are not further processed because the remaining size of the NMS_Retaining_Terms is less that a known size (i.e., four in graph 206).

Graph 205 illustrates the NE_Term E being retained 210. When NE_Term E is retained 210, the segments in the NE_Terms graph which include NE_Term B are removed from the NE_Terms graph (i.e., the segment from NE_Term A to NE_Term B and from NE_Term E to NE_Term B). However, because these segments have been removed, a new segment must be added between NE_Term A and NE_Term E. Once NE_Term E has been retained 210, the preceding term, NE_Term B is dropped, the subsequent term, NE_Term F is processed and retained, at which point the NMS_Retaining_Terms subset is defined as {A, E, F, G}.

For example, FIG. 3 illustrates a mutating graph 300 with two directed linear graphs, NE_Terms and NMS_Terms.

FIG. 3 illustrates the combination of the two directed linear graphs, the NMS_Terms in dashed lines and the NE_Terms in solid lines. Graph 301 represents NMS_Terms A and B having been processed and processing NE_Term C. NE_Term C may be dropped 209 or retained 210. FIG. 3 illustrates the outcome when NE_Term C is retained 210. FIG. 2 illustrates the outcome when NE_Term C is dropped 209.

Graph 302 illustrates the NE_Term C being retained 308. When NE_Term C is retained 308, the segments in the NE_Terms graph which include NE_Term B are removed from the NE_Terms graph (i.e., the segment from NE_Term A to NE_Term B and from NE_Term C to NE_Term B). However, because these segments have been removed, a new segment must be added between NE_Term A and NE_Term C. Once NE_Term C has been retained 308, the preceding term, NE_Term B is dropped.

Graph 303 illustrates the next NE_Term to be processed which NE_Term E and dropping 307 NE_Term E. NE_Term E is dropped 307 because there is no direct path from the previous NE_Term D to the current NE_Term E in the direction of the NMS_Terms linear graph. Therefore, when NE_Term E is dropped 307, the segments in the NE_Terms graph which include NE_Term E are removed from the NE_Terms graph (i.e., the segment from NE_Term F to NE_Term E and from NE_Term E to NE_Term D). However, because these segments have been removed, a new segment must be added between NE_Term D and NE_Term F.

Graph 304 illustrates the NE_Term E being retained 308. When NE_Term E is retained 308, the segments in the NE_Terms graph which include NE_Term D are removed from the NE_Terms graph (i.e., the segment from NE_Term C to NE_Term D and from NE_Term C to NE_Term E). However, because these segments have been removed, a new segment must be added between NE_Term C and NE_Term E. Once NE_Term E has been retained 308, the preceding term, NE_Term D is dropped. The NE_Terms F and G are also retained 308. Once NE_Term E has been retained 308, the subsequent term, NE_Terms F and G remain processed and retained, at which point the NMS_Retaining_Terms subset is defined as {A, C, E, F, G}, which is the largest NMS_Retaining_Terms subset.

Graph 305 illustrates the next NE_Term to be processed which NE_Term F and dropping 307 NE_Term F. NE_Term F is dropped 307 because there is no direct path from the previous NE_Term D to the current NE_Term F in the direction of the NMS_Terms linear graph. Therefore, when NE_Term F is dropped 307, the segments in the NE_Terms graph which include NE_Term F are removed from the NE_Terms graph (i.e., the segment from NE_Term F to NE_Term D and from NE_Term G to NE_Term F). However, because these segments have been removed, a new segment must be added between NE_Term D and NE_Term G. Once NE_Term F has been dropped 307, the subsequent term, NE_Term G is processed and retained, at which point the NMS_Retaining_Terms subset is defined as {A, C, D, G}.

Graph 306 illustrates the NE_Term F being retained 308. When NE_Term F is retained 308, the segments in the NE_Terms graph which include NE_Term D are removed from the NE_Terms graph (i.e., the segment from NE_Term D to NE_Term C and from NE_Term D to NE_Term F). However, because these segments have been removed, a new segment must be added between NE_Term C and NE_Term F. Once NE_Term F has been retained 308, the preceding term, NE_Term D is dropped, at which point the NMS_Retaining_Terms subset is defined as {A, C, F, G}.

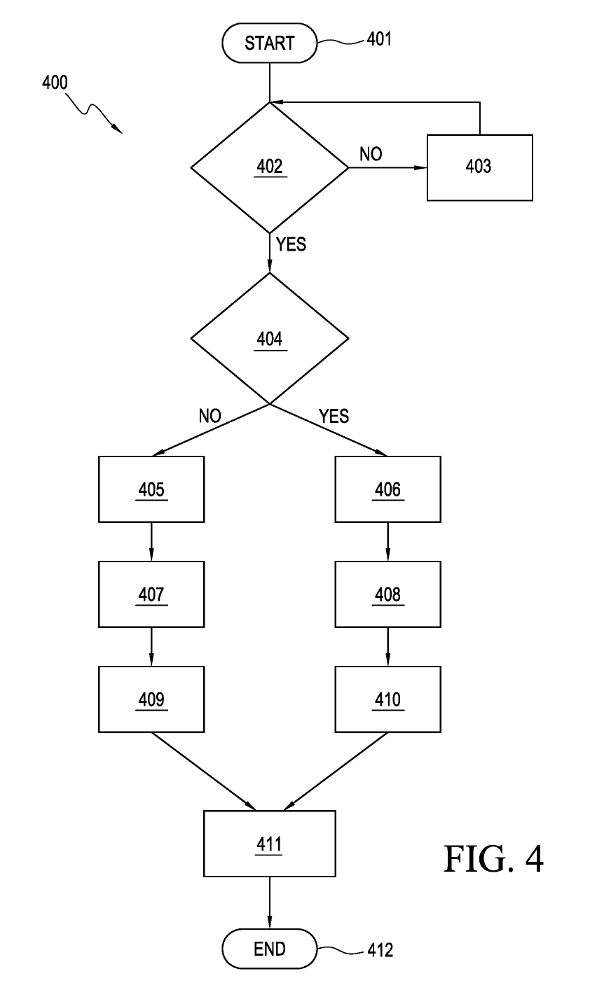

FIG. 4 illustrates a method for existing network management systems to consolidate entries having textual identification with entries having numerical identification. The method 400 begins at step 401 and continues to step 402 which determines whether every term in the NE_Terms is in the NMS_Terms. If yes, proceeding to step 404. If no, proceeding to step 403 to drop that term, then proceed to step 404 to determine again whether every term in the NE_Terms is in the NMS_Terms.

The method 400 proceeds to step 404 which verifies whether there is a path in the NMS_Terms directed linear graph connecting a preceding term in the NE_terms to a current term in the NE_Terms. If no, proceeding to step 405 and dropping the current term in the NE_Terms from a first directed graph and keeping the preceeding term in the NE_Terms. If yes, proceeding to step 406 and keeping the current term in the NE_Terms in a first directed graph and dropping the preceding term in the NE Terms.

The method 400 proceeds from step 405 to step 407 to evaluate a term subsequent to the current term by verifying whether there is path in the NMS_Terms directed linear graph connecting the preceding term in the NE_Terms to the term in the NE_Terms.

The method 400 proceeds from step 406 to step 408 to reevaluate the current term by verifying whether there is a path in the NE_Terms directed linear graph connecting a preceding term in the NE_Terms to the current term in the NE_Terms.

The method 400 proceeds from step 408 to step 410 which generates a directed linear graph where the current term is retained.

The method 400 proceeds from step 407 to step 409 which generates a directed linear graph where the current term is dropped.

The method 400 proceeds from step 409 and 410 to step 411 which terminates when the NMS_Retaining_Terms are less than another set of NMS_Retaining_Terms.

The method 400 proceeds to end at step 412.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A non-transitory machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media and excludes transitory signals.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for synchronization of a first set of policy terms with a second set of policy terms by performing iteration on the second set of policy terms, the method comprising the steps of:
verifying whether there is a path in a directed linear graph for a first set of policy terms connecting a preceding term in the second set of policy terms to a current term in the second set of policy terms; and
dropping the current term in the second set of policy terms from a directed graph for a second set of policy terms and keeping the subsequent term in the second set of policy terms.

2. The method of claim 1, further comprising:
determining whether every term in the second set of policy terms is in the first set of policy terms and if any term in the second set of policy terms is not in the first set of policy terms, the term is dropped from the second set of policy terms.

3. The method of claim 1, further comprising:
evaluating a term subsequent to the current term by verifying whether there is a path in the directed graph for the first set of policy terms connecting a preceding term in the second set of policy terms to the term in the second set of policy terms.

4. The method of claim 1, further comprising:
generating the directed graph for the second set of policy terms wherein the current term is dropped.

5. The method of claim 1, further comprising:
terminating the method when a third set of policy terms for the directed linear graph for the second set of policy terms are less than a third set of policy terms for another directed linear graph for a second set of policy terms, wherein
the third set of policy terms are network management system retained terms.

6. The method of claim 1, wherein the first set of policy terms are network management system terms, the second set of policy terms are network equipment terms.

7. A method for synchronization of a first set of policy terms with a second set of policy terms by performing iteration on the second set of policy terms, the method comprising the steps of:
verifying whether there is a path in a directed linear graph for a first set of policy terms connecting a preceding term in the second set of policy terms to a current term in the second set of policy terms; and
keeping the current term in the second set of policy terms from a directed graph for a second set of policy terms and dropping the preceding term in the second set of policy terms.

8. The method of claim 7, further comprising:
determining whether every term in the second set of policy terms is in the first set of policy terms and if any term in the second set of policy terms is not in the first set of policy terms, the term is dropped from the second set of policy terms.

9. The method of claim 7, further comprising:
reevaluating the current term by verifying whether there is a path in the directed linear graph for the first set of policy terms connecting a preceding term in the second set of policy terms to the current term in the second set of policy terms.

10. The method of claim 7, further comprising:
generating a directed graph for a second set of policy terms wherein the current term is retained.

11. The method of claim 7, further comprising:
terminating the method when a third set of policy terms for the directed linear graph for the second set of policy terms are less than a third set of policy terms for another directed linear graph for a second set of policy terms, wherein
the third set of policy terms are network management system retained terms.

12. The method of claim 7, wherein the first set of policy terms are network management system terms, the second set of policy terms are network equipment terms.

13. A non-transitory machine-readable storage medium encoded with instructions executable to perform a method by a processor for synchronization of a first set of policy terms with a second set of policy terms by performing iteration on the second set of policy terms, the machine-readable storage medium comprising:
instructions for verifying whether there is a path in a directed linear graph for a first set of policy terms connecting a preceding term in the second set of policy terms to a current term in the second set of policy terms; and
instructions for dropping the current term in the second set of policy terms from a directed graph for a second set of policy terms and keeping the subsequent term in the second set of policy terms.

14. The non-transitory machine-readable storage medium of claim 13, further comprising:
instructions for determining whether every term in the second set of policy terms is in the first set of policy terms and if any term in the second set of policy terms is not in the first set of policy terms, the term is dropped from the second set of policy terms.

15. The non-transitory machine-readable storage medium of claim 13, further comprising:
instructions for evaluating a term subsequent to the current term by verifying whether there is a path in the directed graph for the first set of policy terms connecting a preceding term in the second set of policy terms to the term in the second set of policy terms.

16. The non-transitory machine-readable storage medium of claim 13, further comprising:
instructions for generating the directed graph for the second set of policy terms wherein the current term is dropped.

17. The non-transitory machine-readable storage medium of claim 13, further comprising:
instructions for terminating the method when a third set of policy terms for the directed linear graph for the second set of policy terms are less than a third set of policy terms for another directed linear graph for a second set of policy terms, wherein
the third set of policy terms are network management system retained terms.

18. The non-transitory machine-readable storage medium of claim 13, wherein the first set of policy terms are network management system terms, the second set of policy terms are network equipment terms.

19. A non-transitory machine-readable storage medium encoded with instructions executable to perform a method by a processor for synchronization of a first set of policy terms with a second set of policy terms by performing iteration on the second set of policy terms, the machine-readable storage medium comprising:
instructions for verifying whether there is a path in a directed linear graph for a first set of policy terms connecting a preceding term in the second set of policy terms to a current term in the second set of policy terms; and
instructions for keeping the current term in the second set of policy terms from a directed graph for a second set of policy terms and dropping the preceding term in the second set of policy terms.

20. The non-transitory machine-readable storage medium of claim 19, further comprising:
instructions for determining whether every term in the second set of policy terms is in the first set of policy terms and if any term in the second set of policy terms is not in the first set of policy terms, the term is dropped from the second set of policy terms.

21. The non-transitory machine-readable storage medium of claim 19, further comprising:
instructions for reevaluating the current term by verifying whether there is a path in the directed linear graph for the first set of policy terms connecting a preceding term in the second set of policy terms to the current term in the second set of policy terms.

22. The non-transitory machine-readable storage medium of claim 19, further comprising:
instructions for generating a directed graph for a second set of policy terms wherein the current term is retained.

23. The non-transitory machine-readable storage medium of claim 19, further comprising:
instructions for terminating the method when a third set of policy terms for the directed linear graph for the second set of policy terms are less than a third set of policy terms for another directed linear graph for a second set of policy terms, wherein
the third set of policy terms are network management system retained terms.

24. The non-transitory machine-readable storage medium of claim 19, wherein the first set of policy terms are network management system terms, the second set of policy terms are network equipment terms.
